(19) United States
(12) Patent Application Publication
(10) Pub. No.: US 2019/0157798 A1
(43) Pub. Date: May 23, 2019

(54) TELECOMMUNICATIONS ENCLOSURE DESIGNS FOR IMPROVED SEALING AND RELIABILITY VIA SUPERABSORBENT POLYMERS

(71) Applicant: CORNING RESEARCH & DEVELOPMENT CORPORATION, Hickory, NC (US)

(72) Inventors: Dana Craig Bookbinder, Corning, NY (US); Wolf Peter Kluwe, Hagen (DE); Claudio Mazzali, Painted Post, NY (US); Martin Schulte, Wildau (DE); Pushkar Tandon, Painted Post, NY (US); Ruchi Tandon, Painted Post, NY (US)

(21) Appl. No.: 15/820,585

(22) Filed: Nov. 22, 2017

(51) Int. Cl. H01R 13/52; G02B 6/44; H01B 7/288

(52) U.S. Cl. CPC H01R 13/5216; H01R 13/5213; C08L 101/14; H01B 7/288; C08L 2205/03; G02B 6/4494

(57) ABSTRACT

Embodiments of a telecommunications equipment enclosure are provided herein. The telecommunications enclosure includes a first portion having a first sealing surface and a second portion having a second sealing surface. The first portion and the second portion define an internal cavity when the first portion and the second portion are in a closed configuration. The telecommunications enclosure also includes a first gasket mounted to either the first sealing surface or the second sealing surface and superabsorbent polymer (SAP) located on at least one of the first portion and the second portion for restricting ingress of water into the internal cavity

### BACKGROUND

The disclosure relates generally to sealed enclosures and more particularly to enclosures for optical fibers, copper lines, or other optical or electrical telecommunications equipment having a watertight seal created at least in part through the use of superabsorbent polymers. Large distribution cables carrying multiple optical fibers or copper lines deliver telecommunication service to distribution nodes, such as to a neighborhood subdivision or a business park. The optical fibers or copper lines are subdivided into branches of single fibers (or copper lines) or groups of fibers (or groups of copper lines) that are spliced or otherwise coupled to drop cables running to homes or businesses. The splice points are contained in an enclosure that may, for example, be suspended from a utility pole. Such enclosures are often, thus, exposed to precipitation and widely varying temperatures. Nevertheless, these enclosures are expected to have a service life of at least five years, while not allowing water to enter the enclosure and degrade the copper lines or optical fibers.

### SUMMARY

In one aspect, embodiments of an equipment enclosure are provided. The equipment enclosure includes a first portion having a first sealing surface and a second portion having a second sealing surface. The first portion and the second portion define an internal cavity when the first portion and the second portion are in a closed configuration. The equipment enclosure also includes a first gasket mounted to either the first sealing surface or the second sealing surface and superabsorbent polymer (SAP) located on at least one of the first portion and the second portion. In some embodiments, an optical, electrical, or opto-electrical component is located within the internal cavity of the equipment enclosure.

In another aspect, embodiments of a system for sealing an enclosure are provided. In particular, the enclosure has a first portion and a second portion that define an internal cavity. The system includes a first gasket and a second gasket. The first gasket is made, at least in part, of SAP, and the first gasket circumscribes the internal cavity. The second gasket circumscribes the first gasket, and further, the first gasket is capable of absorbing from 50 grams to 1000 grams of water per gram of SAP.

In still another aspect, embodiments of an enclosure are provided. The enclosure includes a first portion having a sealing surface and a second portion. The first portion and the second portion define an internal cavity when the first portion and the second portion are in a closed configuration. The enclosure also includes a first gasket made, at least in part, of SAP, and the first gasket is mounted to the second portion in such a way as to oppose the sealing surface in the closed configuration. Further, the first gasket is configured to prevent ingress of water while the enclosure is submerged under 15 cm of water for 30 min.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an enclosure with SAP, according to an exemplary embodiment;

FIG. 2 depicts pressure sensor data of an enclosure;

FIG. 3 depicts pressure sensor data of an enclosure;

FIG. 4 is a perspective view of another embodiment of an enclosure with SAP;

FIG. 5 is a perspective view of yet another embodiment of an enclosure with SAP;

FIG. 6 is a perspective view of still another embodiment of an enclosure with SAP; and

FIG. 7 is a graph of the water swelling capacities of three superabsorbent, swellable hot melts suitable for use in an telecommunications enclosure.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

Referring generally to the figures, various embodiments of a telecommunications enclosure including a region of superabsorbent polymer are provided. Generally, telecommunications enclosures are deployed in ways that subject them to highly variable weather conditions. For example, telecommunications enclosures may experience temperature cycling from −40° C. to 70° C. as well as various forms and amounts of precipitation. Such telecommunications enclosures are nevertheless expected to have long operation lives (e.g., 5 to 20 years or more) while also not experiencing leaks that might otherwise damage the cables, fibers, and other components contained therein. As disclosed herein, superabsorbent polymers are utilized to replace or supplement sealing gaskets to restrict or prevent water from seeping into the interior of the telecommunications enclosure. In various exemplary embodiments, the superabsorbent polymer is applied in one or more strips of tape at a first end, a second end, or at both the first and second ends of the enclosure, as a redundant sealing feature. While an telecommunications enclosure is used herein to facilitate description of the inventive concepts, the present disclosure relates to other forms of enclosures, terminals, cabinets, or other water-resistant products or portions of a product where a water resistant or watertight sealing is desired for at least a portion of the product. The embodiments described herein are presented by way of example, and not by way of limitation, and a person having ordinary skill in the art will recognize from the present disclosure other embodiments falling within the scope of the invention.

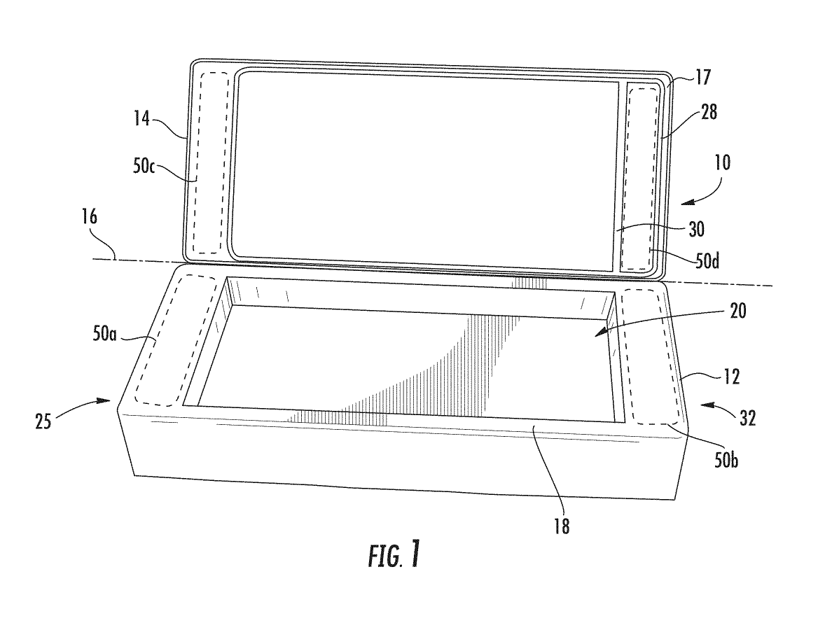

As shown in FIG. 1, a telecommunications enclosure 10 (also referred to herein as an equipment enclosure) is illustrated according to an exemplary embodiment. Broadly, telecommunications enclosures 10 are used to protect telecommunications cable divisions that result from delivering, for example, fiber or copper lines to a home, to a multi-dwelling unit, to a business, or other location. In particular, branches of distribution cables carrying multiple optical fibers or copper lines are often carried on utility poles. One or more fibers or copper lines are divided from these branches and spliced to drop cables coming from a home, multi-dwelling unit, or business. The telecommunications enclosure 10 is configured to protect such splice points, and thus, enclosures 10 are generally suspended from aerial cables or mounted to utility poles or buildings (but may also be placed underground in some applications).

In the embodiment depicted, the enclosure 10 includes a first portion, which is depicted as a bin portion 12, and a second portion, which is depicted as a lid 14. As shown in FIG. 1, the bin portion 12 and the lid 14 are joined via a hinge (not shown) that allows the lid 14 to rotate about the longitudinal axis 16 from an open position to a closed position, and vice versa. In FIG. 1, the lid 14 is depicted in the open position. In the closed position, the lid 14 is rotated towards the bin portion 12 so that the enclosure 10 generally has the shape of a rectangular prism. In other embodiments, the telecommunications enclosure 10, the bin portion 12, and the lid 14 can take a variety of other shapes. For example, in an embodiment, the bin portion 12 and the lid 14 both have cylindrical cross-sections such that the telecommunications enclosure 10 has a cylindrical shape. In still other embodiments, the bin portion 12 is a dome and the lid 14 is an end cap such that the telecommunications enclosure 10 has a truncated pill-shape.

Returning to the rectangular prism embodiment depicted in FIG. 1, the lid 14 is characterized by a first peripheral surface 17, also referred to herein as a first sealing surface, and the bin portion 12 is characterized by a second peripheral surface 18, also referred to herein as a second sealing surface. The first peripheral surface 17 and the second peripheral surface 18 both circumscribe an internal cavity 20. The lid (first portion) 14 and bin portion (second portion) 12 define the internal cavity 20 when the first peripheral surface (first sealing surface) 17 contacts the second peripheral surface (second sealing surface) 18 and the lid 14 is in a closed configuration. While not shown for the purposes of simplicity of illustration, one or more ports or openings may be formed through the bin portion 12 of the telecommunications enclosure 10, for example, at a first end 25 of the telecommunications enclosure 10, to allow entry of optical fibers, optical fiber cables, copper lines, or copper cables into the internal cavity 20. In other embodiments, the ports or openings may be located at other positions of the bin portion 12 or the lid 14. The ports allow for optical or copper cables to be inserted into the telecommunications enclosure 10 and spliced in the internal cavity 20. In embodiments, grommets (not shown), such as elastomeric grommets, are fitted into the ports to provide watertight sealing around the cables when such cables are inserted through the ports.

In FIG. 1, a peripheral gasket 28, also referred to herein as a first gasket, is provided on the lid 14; although, the peripheral gasket 28 may be provided on the bin portion 12 in other embodiments. In the embodiment of FIG. 1, the peripheral gasket 28 is located on the first peripheral surface 17 of the lid 14. As can be seen in FIG. 1, the peripheral gasket 28 generally matches the surface of the second peripheral surface 18 such that, when the lid 14 is in the closed position, a seal is created between the lid 14, the first peripheral gasket 28, and the second peripheral surface 18 of the bin portion 12. Creation of the seal can further be facilitated by using clamps, bolts, screws, and/or other fasteners on the telecommunications enclosure 10.

In embodiments, the first peripheral gasket 28 is made from an elastomeric material or reversibly deformable material, such as natural rubber, isoprene, ethylene propylene diene (EPDM), nitrile rubber (copolymer of butadiene and acrylonitrile), styrene butadiene rubber (SBR), silicone, butyl rubber, polybutadiene, and urethane, for example. In another embodiment, the first peripheral gasket 28 is a thermoplastic elastomer, such as an ionomer or block copolymer (e.g., syrene-butadiene-sytrene block copolymer).

In embodiments, the peripheral gasket 28 has a cross-sectional width of from 1 mm to 10 mm. In particular embodiments, the peripheral gasket 28 has a cross-sectional width of from 4 mm to 6 mm. The width refers to the widest measurement across the cross-section, which can be circular, rectangular, oval, elliptical, or another polygonal or curved shape.

The first peripheral gasket 28 of the embodiment in FIG. 1 has a seal line 30 the forms a double seal at a second end 32 (i.e., end opposite to the first end 25) of the telecommunications enclosure 10. The seal line 30 is positioned between the first peripheral surface 17 and the second peripheral surface 18 when the lid 14 is in a closed position to create a seal between the bin portion 14 and the lid 12. As mentioned above, in one embodiment, ports where the optical fiber or copper cables enter and exit the telecommunications enclosure 10 are located at the first end 25. Thus, in such an embodiment, the second end 32 is a dead end, i.e., it contains no ports, and accordingly, a double seal using the seal line 30 is provided at the second end 32. However, in other embodiments, the double seal is provided at both the first end 25 and the second end 32, or the double seal is provided only at the first end 25.

In certain circumstances, the molding of the components of the telecommunications enclosure 10 can create sink marks (i.e., slight undulations instead of a perfectly flat or planar surface), especially along the first or second peripheral surfaces 17, 18, as a result of shrinkage during the molding process. These sink marks are a potential source of leakage of fluids into the interior of the telecommunications enclosure 10 over time. Additionally, because the telecommunications enclosure 10 may be exposed to temperatures as low as −40° C. and as high as 70° C., the thermal expansion and/or contraction of the different components or parts of the lid 14 and bin portion 12 at different rates can exacerbate the effect of sink marks. For example, at cold temperatures, the elastomeric material of the first peripheral gasket 28 may pull back, deform less, or not fill such sink marks as fully as at higher temperatures. Further, at high temperatures, the expansion of the components can create larger gaps between sealing surfaces such as the first and second peripheral surfaces 17, 18.

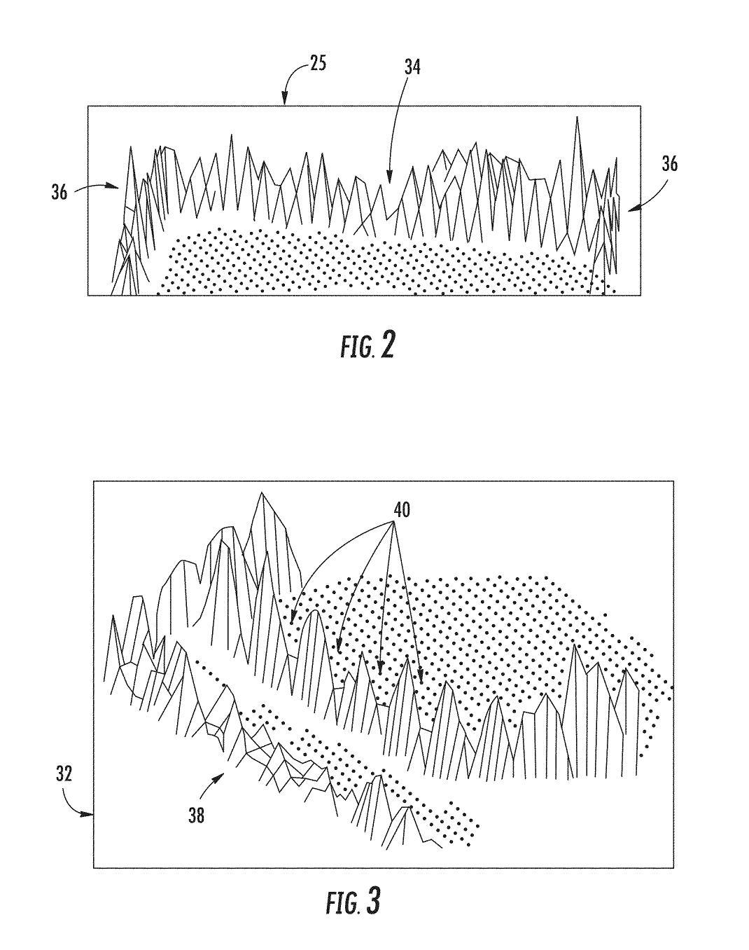

For example, FIGS. 2 and 3 show pressure sensor data obtained during a first experiment using an telecommunications enclosure similar to the telecommunications enclosure 10 depicted in FIG. 1. FIG. 2 depicts pressure sensor data obtained at the first end 25 and FIG. 3 depicts pressure sensor data at the second end 32. Pressure sensor data was collected using a pressure sensor array (available from Tekscan, Inc., Boston, Mass.) positioned between the first peripheral surface 17 and the second peripheral surface 18. As shown in FIGS. 2 and 3, the peaks represent the relative pressure along the line of sealing provided by the peripheral gasket 28 and seal line 30. As can be seen in FIG. 2, a region 34 near the middle of the first end 25 of the enclosure 10 has much lower relative seal pressure than at the sides 36. Similarly, in FIG. 3, a large segment 38 along the second end 32 where the first peripheral gasket 28 is located has a low seal pressure. Additionally, several dips 40 in pressure can be seen along the second end 32 where the seal line 30 is located. The region 34, segment 38, and dips 40 are all potential locations for fluid to enter the telecommunications enclosure 10 over time absent further sealing.

Indeed, a second experiment in which the above referenced telecommunications enclosure was submerged under 15 cm of water at room temperature for 30 minute. Before submerging the telecommunications enclosure 10 under water, the telecommunications enclosure 10 was clamped closed to create a seal between the first peripheral surface 17, the second peripheral surface 18, the first peripheral gasket 28, and the seal line 30. Upon opening the telecommunications enclosure 10 after removing it from the water at the end of the 30 minute time period, some water could be seen in the internal cavity 20 of the telecommunications enclosure 10.

In order to limit or restrict, or in some cases eliminate, fluid leakage into the telecommunications enclosure for the useful life of the enclosure 10, superabsorbent polymer (SAP) may be applied at various locations of the telecommunications enclosure 10 as further described herein. As used herein, the term superabsorbent polymer (or SAP) means a material comprising a water-swellable polymer that can absorb and retain from about 50 grams to about 1,000 grams of water per gram of the material. Thus, the term superabsorbent polymer or SAP, as used herein, includes materials or combinations of materials that are not entirely polymers. For example, the term superabsorbent polymer or SAP as used herein includes a non-polymer binder having a water-swellable polymer dispersed therein.

In the embodiment of FIG. 1, the SAP may be applied to the lid 14, the bin portion 12, or both the lid 14 and the bin portion 12 to restrict, or eliminate, fluid leakage and to compensate for sink marks, thermal expansion/contraction, or other sealing deficiencies in an telecommunications enclosure 10 for some or all of the useful life of the enclosure 10.

Returning to the embodiment shown in FIG. 1, the dashed rectangles represent locations 50a, 50b, 50c, 50d where SAP can be applied to the telecommunications enclosure 10. For example, in some embodiments, the SAP is applied at locations 50a and 50b on the bin portion 12, while in other embodiments, the SAP is applied at locations 50c and 50d on the lid 14. Further, in exemplary embodiments, the SAP is applied at location 50c on the lid 14 and 50b on the bin portion 12, or in other embodiments, the SAP can be applied at location 50d on the lid 14 and 50a on the bin portion 12. In still another embodiment, the SAP is applied at all of the locations 50a, 50b, 50c, 50d on the lid 14 and bin portion 12.

In some embodiments, one or more of the locations 50a, 50b, 50c, and 50d are recessed into the peripheral surfaces 17, 18 so that the SAP is located within the recesses. In other embodiments, one or more of the locations 50a, 50b, 50c, and 50d are coplanar with the peripheral surfaces 17, 18 so that the SAP is located at the surface of the peripheral surfaces 17, 18. When the SAP at one or more of locations 50a, 50b, 50c, or 50d is recessed into the peripheral surfaces 17, 18, the SAP is not compressed or experiences relatively less compression than when the SAP one or more of the locations 50a, 50b, 50c, or 50d, respectively, sits on the surface of the peripheral rim 18 or lid 14. That is, when the SAP at location 50a, location 50b, location 50c, or location 50d sits on the surface of the peripheral surfaces 17, 18, the SAP is compressed, at least in part, either between the lid 14 and the bin portion 12, or between the lid 14 or bin portion 12 and the first peripheral gasket 28 when the lid 14 and the bin portion 12 are in a closed configuration. In other embodiments, the SAP is located such that is it not between the first peripheral surface 17, the second peripheral surface 18, or the first peripheral gasket 28 when the lid 14 and the bin portion 12 are in a closed configuration.

The SAP may be in the form of a powder, fabric, tape, hot melt, dispursed in the material of a grommet, or other form factor. Referring again to FIG. 1, for example, the SAP at locations 50a, 50b, 50c, 50d may be in the form of a tape (e.g., water swellable tape, water blocking tape, SAP tape, etc.) that is adhered to one or more of the locations 50a, 50b, 50c, 50d. In other embodiments, the SAP is in the form of a powder or fabric that is bonded (e.g., glued) to one or more of the locations 50a, 50b, 50c, 50d. In still other embodiments, the SAP is in the form of a hot melt, i.e., a superabsorbent, swellable hot melt (SA-SHIM) that is deposited onto one or more of the locations 50a, 50b, 50c, 50d. Besides the form that the SAP takes, the composition of the SAP vary, and various compositions for the SAP as well as the matrix in which it is deployed are described in more detail below.

Further, while FIG. 1 only depicts locations at the first end 25 and second end 32 of the telecommunications enclosure 10, the SAP may be located at other locations in other embodiments. For example, the SAP may be located (exclusively or additionally) along the sides that run perpendicular to the first end 25 and to the second end 32 of the lid 14, of the bin portion 12, or of both the lid 14 and the bin portion 12. Further, applying the SAP only at locations 50a, 50b, 50c, 50d defines a discontinuous application of the SAP around the peripheral surfaces 17, 18. In other words, the SAP only partially circumscribes the internal cavity 20. However, in other embodiments, the SAP is applied continuously around the peripheral surfaces 17, 18, i.e., the SAP circumscribes the internal cavity 20.

At each location 50a, 50b, 50c, 50d, the SAP can have a thickness of up to 10 mm in some embodiments. In other embodiment, the SAP and/or SA-SHM has a thickness of up to 5 mm, and in still other embodiments, the SAP and/or SA-SHM has a thickness of up to 2 mm. The SAP has a thickness of at least 0.05 mm in embodiments.

In a particular embodiment, SAP tape was applied on the surface of the peripheral rim 18 at locations 50a, 50b, and the second experiment was performed again. More specifically, after applying the SAP tape, the telecommunications enclosure 10 was again clamped closed to create a seal between the peripheral gasket 28, seal line 30, the SAP tape at locations 50a, 50b, and the peripheral rim 18. After clamping the telecommunications enclosure 10, the telecommunications enclosure 10 was submerged under 15 cm of water at room temperature for 30 minutes, and upon opening the telecommunications enclosure 10 at the end of the test, substantially no water had penetrated the internal cavity 20 of the telecommunications enclosure 10. That is, the SAP tape was able to prevent the ingress of water into the internal cavity 20 of the telecommunications enclosure 10 during the test. This test, in which the closure is submerged in 15 cm of water at room temperature for 30 minutes, may, in some instances, be used to predict the performance of the telecommunications enclosure 10 over some or all of its operational or useful lifetime, depending on the intended location and use for the enclosure 10. The use of SAP in its various forms and compositions described herein as part of the telecommunications enclosure 10 is designed to prevent the ingress of water into the internal cavity 20 of the telecommunications enclosure 10 during its operational lifetime. In some circumstances, the operational life of the telecommunications enclosure 10 is from five to twenty years. After the operational life of the telecommunications enclosure 10, applicants believe that the SAP continues to substantially prevent the ingress of water into the internal cavity 20 of the telecommunications enclosure 10, and any ingress of water into the internal cavity 20 is believed to be minimal.

FIG. 4 depicts another embodiment of an telecommunications enclosure 10′ including at least one SAP gasket 60. An SAP gasket is a matrix in which one or more SAP powders are distributed throughout the thickness of the matrix, on the surface of the matrix, or to a certain depth in the matrix. In particular, a first SAP gasket 60 is located on the lid 14 and circumscribes the internal cavity 20. The first peripheral gasket 28 circumstribes the first SAP gasket 60. In some embodiments, the first SAP gasket 60 has a cross-sectional width of from 1 mm to 10 mm. In particular embodiments, the first SAP gasket 60 has a cross-sectional width of from 4 mm to 6 mm. Similar to the peripheral gasket 28, the width refers to the widest measurement across the cross-section, which can be circular, rectangular, oval, elliptical, or another polygonal or curved shape.

In the depicted embodiment, a second SAP gasket 62 is provided near the second end 32 of the enclosure 10′ and is circumscribed by the peripheral gasket 28 and the seal line 30. In embodiments, the second SAP gasket 62 has a cross-sectional width of from 1 mm to 10 mm. In particular embodiments, the second SAP gasket 62 has a cross-sectional width of from 4 mm to 6 mm. As with the first SAP gasket 60, the width refers to the widest measurement across the cross-section, which can be circular, rectangular, oval, elliptical, or another polygonal or curved shape. Further, in some embodiments, the first SAP gasket 60 and the second SAP gasket 62 have different widths or shapes or different widths and shapes. Moreover, the widths, and shapes of the first SAP gasket 60 and the second SAP gasket 62 can be different from the width or shape of the peripheral gasket 28.

Additionally, in some embodiments, at least one of the first SAP gasket 60 and the second SAP gasket 62 abuts or contacts the peripheral gasket 28 when the SAP gaskets 60, 62 are not exposed to a liquid. However, in other embodiments, neither of the first SAP gasket 60 and the second SAP gasket 62 abuts or contacts the peripheral gasket 28 when the SAP gaskets 60, 62 are not exposed to water or another fluid, which provides additional room for the first SAP gasket 60 or second SAP gasket 62 to expand when exposed to water or another fluid. In each of the described embodiments, the SAP gaskets 60, 62 helps to prevent ingress of water into the internal cavity 20.

Still further, in embodiments, the peripheral gasket 28 has an open cell porosity, i.e., interconnected pores. Open cell porosity would allow water to transfer through pore conduits to one or both of the first SAP gasket 60 and the second SAP gasket 62, causing the SAP gasket 60 or SAP gaskets 60, 62 to swell. In some embodiments, the SAP gasket 60 or SAP gaskets 60, 62 would swell and enter and close off the pores of the peripheral gasket 28, creating an interlock between one or both of the first SAP gasket 60 and the second SAP gasket 62 and the open cell peripheral gasket 28. However, in other embodiments, the peripheral gasket 28 has a closed cell porosity, i.e., pores substantially closed off from each other, such that substantially no water (or other fluid) is able to transport through the peripheral gasket 28.

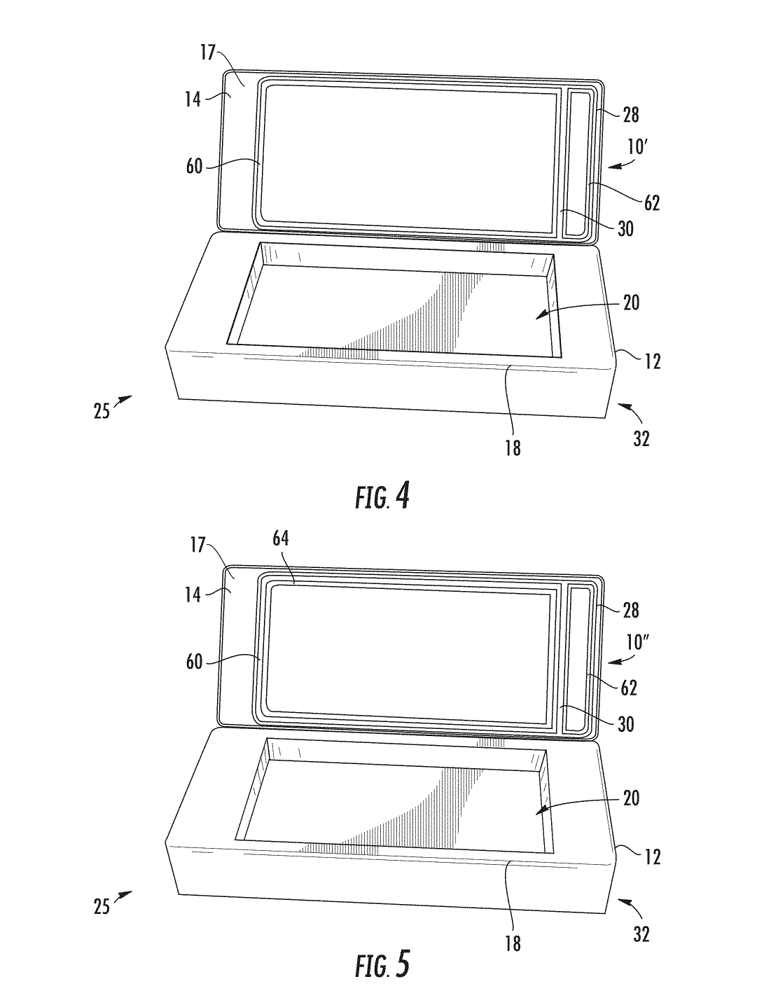

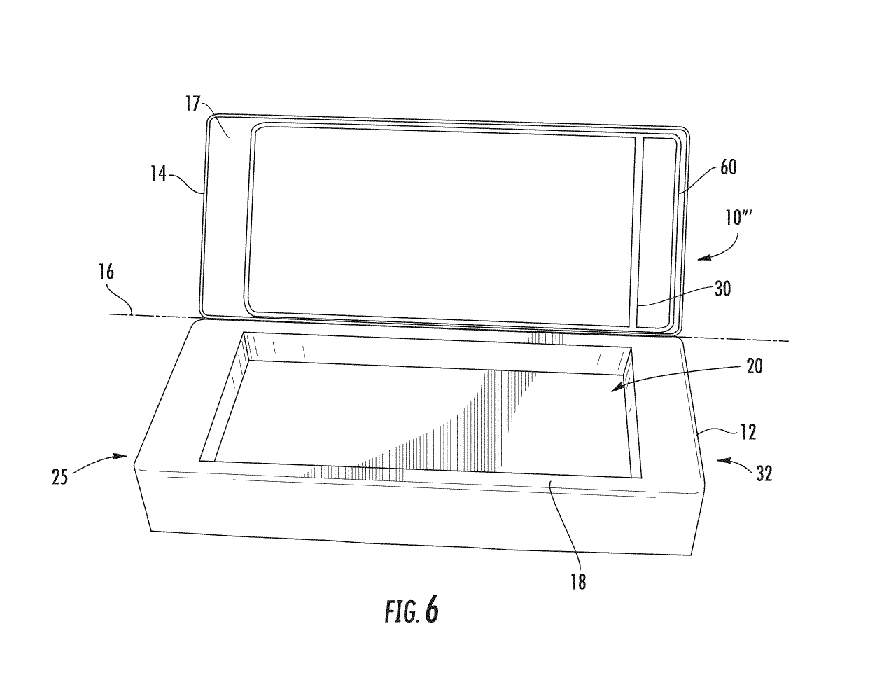

FIG. 5 provides still another embodiment of an telecommunications enclosure 10″ in which a secondary peripheral gasket 64 is provided. The second peripheral gasket, also refered to herein as the second gasket 64, circumscribes the internal cavity 20. The SAP gasket 60 is located between the first peripheral gasket 30 and the second peripheral gasket 64. In embodiments, the second peripheral gasket 64 has a cross-sectional width of from 1 mm to 10 mm. In particular embodiments, the second peripheral gasket 64 has a cross-sectional width of from 4 mm to 6 mm. The width refers to the widest measurement across the cross-section, which can be circular, rectangular, oval, elliptical, or another polygonal or curved shape. Further, in embodiments, the second peripheral gasket 64 has a width or shape different than the peripheral gasket 28. Moreover, in embodiments, the first SAP gasket 60 abuts the second peripheral gasket 64, whereas in other embodiments, the first SAP gasket 60 does not abut the second peripheral gasket 64 so as to provide additional room for expansion upon absorption of fluid.

The secondary peripheral gasket 64 helps maintain the positioning of the first SAP gasket 60 in the case that the SAP gasket 60 absorbs a large amount of water (or other fluid) and swells. Further, in embodiments, one or both of the peripheral gasket 28 and the secondary gasket 64 has an open cell porosity. Open cell porosity would allow water to transfer through pore conduits to the SAP gasket 60, causing the SAP gasket 60 to swell, and the SAP gasket 60 would enter and close off the pores, creating an interlock between the SAP gasket 60 and the open cell peripheral gasket 28 and/or the secondary peripheral gasket 64. However, one or both gaskets 28, 64 in other embodiments may have a closed cell porosity.

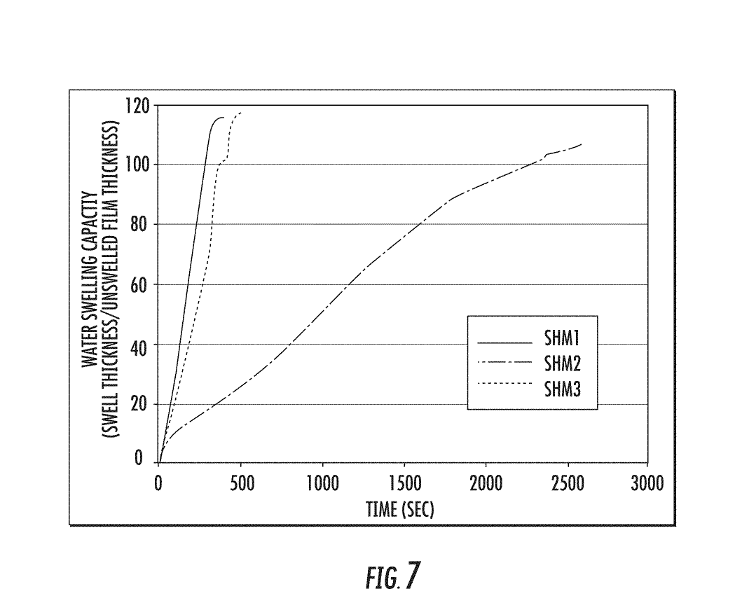

In yet another embodiment shown in FIG. 6, the telecommunications enclosure 10′″ does not include a peripheral gasket 28 or a secondary peripheral gasket 64. Instead, the only gasket is an SAP gasket 60. Optionally, the SAP gasket 60 can include a seal line 30 that is made of the same material as the SAP gasket 60. However, in certain embodiments, the seal line 30 is not included as part of the SAP gasket 60. In such embodiments, the SAP gasket 60 can be an SA-SHM. For example, the SA-SHM may be comprised of a hot melt matrix in which one or more SAP powders are suspended. That is, the SAP powders are distributed throughout the thickness of the hot melt matrix and not just on the surface of the hot melt or not just to a certain depth of the hot melt. The hot melt matrix additionally provides a connective matrix by which to keep the coating together when the SAP powders expand upon contacting water. In other embodiments, the SAP gasket 60 can be an elastomer or a thermoplastic elastomer that is coated or impregnated with SAP.

The SAP for use in the telecommunications enclosures described above may take many forms. As described above, the SAP may be in the form of a tape, a hot melt, an SAP gasket, a powder, or some other configuration. In addition, the SAP used may itself take many forms and may have many compositions. However, generally, the water absorption capacities of the SAP used in the embodiments of the telecommunications enclosures disclosed herein will be greater than 50 grams of water absorbed per gram of SAP and less than about 1,000 grams of water absorbed per gram of SAP. In other embodiments, the water absorption capacity of the SAP is greater than 100 grams of water absorbed per gram of SAP. In still other embodiments, the water absorption capacity of the SAP is greater than 150 grams of water absorbed per gram of SAP. In yet other embodiments, the water absorption capacity of the SAP is greater than 200 grams of water absorbed per gram of SA-SHM. Further, the SAP may have a maximum water absorption capacity of 500 grams of water absorbed per gram of SAP. In other embodiments, the SAP used may have a maximum water absorption capacity of 1000 grams of water absorbed per gram of SAP. In yet other embodiments, the SAP has a water absorption capacity maximum of about 400 grams of water per gram of SAP or SA-SHM.

As mentioned above, the SAP gaskets 60, 62 are made of SA-SHM in certain embodiments. In such embodiments, the SA-SHM is comprised of a hot melt matrix in which one or more SAP powders are suspended. As discussed above, the SAP powders may be distributed throughout the thickness of the hot melt matrix and not just on a surface of the hot melt or not just to a certain depth of the hot melt. In this way, the hot melt matrix additionally provides a connective matrix by which to keep the coating together when the SAP powders expand upon contacting water or another fluid.

In some embodiments, the SA-SHM used are physically setting thermoplastic materials. For example, these may include commercially available water-swellable hot melt adhesives such as HM002 and HM008B (available from Stewart Superabsorbents, Hickory, N.C.), Technomelt AS 4415 (also known as Macromelt Q 4415 available from Henkel Corp., Madison Heights, Mich.), and NW1117 and NW1120B (Hydrolock® super absorbent thermoplastic available from H. B. Fuller Company, Vadnais Heights, Minn.).

Additionally, a variety of exemplary SAP compositions are provided in the following paragraphs. According to one embodiment, the SAP is a SA-SHM, and the SA-SHM includes three components that are mixed homogenously. The first component is a water-insoluble component containing at least one water-insoluble polymer or copolymer and at least one other substantially water-insoluble resin. For example, the first component can be selected from polyamides, copolyamides, polyaminoamides, polyesters, polyacrylates, polymethacrylates, polyolefins and ethylene/vinyl acetate (EVA) copolymers. Further the first component can be mixtures of one or more of the foregoing polymers. The second component is a water-soluble or water-dispersible component containing at least one water-soluble or water-dispersible oligomer and/or polymer or copolymer. For example, the second component can be selected from polyethylene glycols with molecular weights of 400 to 20,000, polyvinyl methyl ether, polyvinyl pyrrolidone, copolymers of vinyl methyl ether or vinyl pyrrolidone, polyvinyl alcohols, water-soluble or water-dispersible polyesters or copolyesters, and water-soluble or water-dispersible acrylate polymers.

The third component is a water-swellable component consisting of a water-swellable homopolymer or copolymer. For example, the third component can be selected from any homopolymers and/or copolymers which, as hydrophilic materials, are capable of absorbing and retaining large amounts of water, even under pressure, without immediately dissolving in the water, including, for example, graft copolymers of starch or cellulose with acrylonitrile, acrylic acid or acrylamide, carboxymethyl cellulose, maleic anhydride/poly-α-olefin copolymers, polyacrylamide, polyacrylic acid and salts of polyacrylic acid, and, optionally, copolymers of acrylic acid or acrylamide with acrylate esters. In embodiments, other suitable the third components include homopolymers and copolymers of acrylic acid or methacrylic acid, acrylonitrile or methacrylonitrile, acrylamide or methacrylamide, vinyl acetate, vinyl pyrrolidone, maleic acid, maleic anhydride, itaconic acid, itaconic anhydride, vinyl sulfonic acid or hydroxyalkyl esters of such acids, 0 to 95% by weight of the acid groups being neutralized with alkali or ammonium groups and these polymers/copolymers are crosslinked by means of polyfunctional compounds. Graft copolymers of starch or cellulose with the above comonomers can also be used in certain embodiments. Still other suitable superabsorbent polymers include crosslinked acrylate polymers, crosslinked products of vinyl alcohol-acrylate copolymers, crosslinked products of polyvinyl alcohols grafted with maleic anhydride, cross-linked products of acrylate-methacrylate copolymers, crosslinked saponification products of methyl acrylate-vinyl acetate copolymers, crosslinked products of starch acrylate graft copolymers, crosslinked saponification products of starch acrylonitrile graft copolymers, crosslinked products of carboxymethyl cellulose polymers, and crosslinked products of isobutylene-maleic anhydride copolymers.

In some embodiments, the SA-SHM also includes a tackifying resin or resins to increase the tackiness of the melt. In particular embodiments, various colophony derivatives, i.e., in particular the resin esters of abietic acid, are used for the tackifying resin; although, in other embodiments, other polyterpenes and terpene/phenol resins are used. Other colophony derivatives include colophony esters of various mono- and poly-functional alcohols. Additionally, suitable tackifying resins include wood rosin, tall oil rosin, tall oil derivatives, gum rosin, rosin ester resins, natural terpenes, synthetic terpenes, and petroleum based tackifying agents, including, e.g., aliphatic, aromatic and mixed aliphatic-aromatic petroleum based tackifying resins. Still further, other suitable tackifying resins include, e.g., alpha-methyl styrene resins, branched and unbranched C₅ resins, C₉ resins and C₁₀ resins, styrenic and hydrogenated modifications thereof, and combinations thereof.

In particular embodiments, the SA-SHM contains the following components: 15 to 45% by weight of resin esters or terpene/phenol resins; 15 to 40% by weight of thermoplastic copolymer, more particularly ethylene/vinyl acetate copolymer; 5 to 20% by weight of acrylate copolymers; 5 to 30% by weight of polyethylene glycols; 5 to 15% by weight of polyvinyl ethyl ethers, water-soluble or water-dispersible acrylate polymers or water-soluble or water-dispersible copolyesters; 15 to 50% by weight of powder-form polyacrylic acid salt, polyacrylamide or similar powdered superabsorbent polymer; and 0.2 to 2.0% by weight of stabilizers, such as, for example, antioxidants based on sterically hindered phenols, that enhance the temperature stability of the compositions.

In other particular embodiments, the SA-SHM contains the following components: 15 to 45% by weight of resin esters, terpene/phenol resins or the like; 15 to 40% by weight of thermoplastic polymer or copolymer, more particularly ethylene/vinyl acetate copolymer; 5 to 25% by weight of polyethylene glycols; 15 to 50% by weight of a powdered superabsorbent polymer, more particularly polyacrylic acid salt; 0.2 to 2.0% by weight of a stabilizer; and 0.5 to 5.0% by weight of waxes, more particularly ethylene bis-stearamide.

In another embodiment of a suitable SA-SHM composition, the SA-SHM is comprised of 10 to 25% by weight of at least one tackifying resin, 20 to 40% by weight of at least one water-dispersible EVA wax, 5 to 25% by weight of at least one ethylene/acrylic acid copolymer, 15 to 35% by weight of at least one water-soluble homopolymer or copolymer, and 20 to 40% by weight of at least one powdered SAP having an average particle size of less than 80 microns.

The tackifying resins can be selected from the same group of tackifying resins discussed above. The water-dispersible EVA waxes are selected from polyethylene waxes based on an ethylene/vinyl acetate copolymer having a vinyl acetate content of up to 15% and molecular weights of between 500 and about 10,000. Flexibilizing ethylene copolymers, particularly ethylene/alkyl acrylate copolymers having an alkyl acrylate proportion of 15 to 40% by weight, are suitable as hydrophobic matrix components for binding the powdered superabsorbent polymer. Longer-chain alkyl acrylic esters are particularly suitable as comonomers in this respect, particularly the C₄-C₁₂ alkyl acrylates.

The water-soluble homopolymer or copolymer can include polyethylene glycol, ethylene oxide/propylene oxide copolymers (either as block copolymers or as random copolymers having a predominate proportion of ethylene oxide), polyvinyl methyl ether, polyvinyl pyrrolidone, polyvinyl alcohol, and copolymers of such monomers with other olefinically unsaturated monomers. In embodiments, these water-soluble polymers have molecular weights of between 1000 and 20,000, they may be liquid at room temperature, or they may be solid and waxy in cases where higher molecular weights are used. Suitable powdered superabsorbent polymers include those listed above.

In still another embodiment, the SA-SHM is comprised of 1% to 25% by weight of a block copolymer, 45% to 75% by weight of a powdered superabsorbent polymer, 15% to 40% by weight of a plasticizing oil, and optionally 1% to 5% by weight of a surfactant. Suitable block copolymers include linear and radial copolymer structures having the formula (A-B)x or A-B-A, where block A is a polyvinylarene block, block B is a poly(monoalkenyl) block, and x is an integer of at least 1. Suitable block A polyvinylarenes include, e.g., polystyrene, polyalpha-methylstyrene, polyvinyltoluene and combinations thereof. Suitable B blocks include, e.g., conjugated diene elastomers including, e.g., polybutadiene and polyisoprene, hydrogenated elastomers, ethylene/butylene (hydrogenated butadiene) and ethylene/propylene (hydrogenated isoprene), and combinations and mixtures thereof. Suitable powdered superabsorbent polymers include those listed above.

Suitable plasticizing oils include, e.g., hydrocarbon oils low in aromatic content, mineral oil. In a particular embodiment, the plasticizing oils are paraffinic or naphthenic. In some embodiments, the SA-SHM can also include tackifying agents, such as those listed above, up to 40% by weight.

In an embodiment, the SA-SHM includes at least one of sodium or potassium sodium acrylate or acrylamide copolymers, cross-linked carboxymethylcellulose, ethylene maleic anhydride copolymers, cross-linked polyethylene oxide, polyvinyl alcohol copolymers, or starch-grafted copolymers of polyacrylonitrile.

Referring to each of the above described SA-SHM compositions and to the use of SAP powders in general, in some embodiments, the average particle size of the SAP powders is between 1 micron and 100 microns. Broadly, in embodiments, the average particle size of the SAP powder is less than or equal to 80 microns. In other embodiments, the average particle size of the SAP powders is less than or equal to 50 microns. In still other embodiments, the average particle size of the SAP powders is less than or equal to 38 microns, and in yet other embodiments, the average particle size of the SAP powders is less than or equal to 25 microns. Further, in embodiments, the average particle size of the SAP powders is greater than 1 micron, and in other embodiments, the average particle size of the SAP powders is greater than 10 microns. Additionally, in embodiments, less than 50% of the SAP powder particles have a maximum outer dimension ≥50 microns. In still other embodiments, less than 10% of the SAP powder particles have a maximum outer dimension ≥38 microns, and in yet other embodiments, less than 10% of the SAP powder particles have a maximum outer dimension ≥25 microns. Further, in embodiments, the SAP powders have particles that are spherical in shape.

Tables 1-2, below, provide examples of the water absorption capabilities of four SA-SHM (referred to individually as “SHM1,” “SHM2,” “SHM3,” and “SHM4”) that can be used as the SAP component of the telecommunications enclosure according to exemplary embodiments. Certain SA-SHM capabilities are compared against a standard SAP powder (referred to as “SAP1”). In particular, SHM1 is commercially available as NW1117 from H.B. Fuller Company, Vadnais Heights, Minn. SHM2 is commercially available as NW1120B from H.B. Fuller Company, Vadnais Heights, Minn. SHM3 is commercially available as HM002 from Stewart Superabsorbents, Hickory, N.C. SHM4 is commercially available as HM008 from Stewart Superabsorbents, Hickory, N.C. SAP1 is a powderized sodium acrylate polymer having particles with average size of about 63 microns (commercially available from Stewart Superabsorbents, Hickory, N.C.). All experiments were performed at room temperature of about 22° C.

The data displayed in Table 1 demonstrates the water absorption capacities of SHM1 and SHM2 as compared to SAP1. In particular, particles of SAP1 and sections of SHM1 and SHM2 were placed in a beaker. The masses of each beaker before and after the addition of SAP1, SHM1, and SHM2 were determined so as to calculate the amount of each material added. A filter as then placed over the beaker, and the mass of the beaker/material/filter combination was determined. Water was added to the beaker, and the materials were given time to absorb as much water as they could. Any remaining, unabsorbed water was drained from the beaker, and the mass of the beaker/material/filter/absorbed water was determined. As can be seen from Table 1, SHM1 and SHM2 absorbed more water on a per gram basis than SAP1.

TABLE 1
Water absorption capacity of SHM Materials compared to SAP Powder

| Material | SAP1 | SHM2 | SHM1 |
|---|---|---|---|
| Mass of Beaker + Stir Bar (g) | 129.70 | 70.10 | 136.15 |
| Mass of Beaker + Stir Bar + SHM Material | 129.84 | 70.23 | 136.32 |
| (g) | | | |
| Mass of SHM Material (g) | 0.14 | 0.13 | 0.17 |
| Mass of Beaker + Filter Assembly (g) | 156.80 | 157.05 | 150.62 |
| Mass of Beaker + Filter Assembly + Swollen | 181.64 | 179.24 | 180.56 |
| Gel (g) | | | |
| Mass of Water Absorbed (g) | 24.69 | 22.05 | 29.76 |
| Mass of Water Absorbed/Mass of SHM | 165.69 | 167.81 | 175.06 |
| Material (g/g) | | | |

The data displayed in Table 2 demonstrates the water absorption capacities of SHM3 and SHM4 as compared to SAP1. In this experiment, the materials were placed on a glass slide. Each of the glass slides were weighed before and after the materials were placed thereon to determine the mass of each material deposited. Water was then added dropwise on the materials over a time up to 10 minutes and until it was visually observed that the material was saturated and the extra water dripped off. The glass slides with gelled material were then weighed to determine the amount of water absorbed. As can be seen in Table 2, SHM3 and SHM4 performed as well or better than SAP1 in terms of water absorbed on a per gram basis.

TABLE 2
Water absorption capacity of SHM materials in experiments of
films on glass slide

| Material | SHM3 | SHM4 | SAP1 |
|---|---|---|---|
| Mass of Glass Slide | 9.272 | 9.263 | 9.263 |
| Mass of Glass Slide + Material (g) | 9.347 | 9.348 | 9.348 |
| Mass of Glass Slide + Gelled Material (g) | 19.468 | 19.650 | 19.650 |
| Mass of Material (g) | 0.075 | 0.085 | 0.082 |
| Mass of Water Absorbed (g) | 10.121 | 10.302 | 10.305 |
| Mass of Water Absorbed/Mass of Gelled | 135.66 | 121.06 | 125.67 |
| Material (g/g) | | | |

FIG. 7 provides a graph of the water swelling capacity of SHM1, SHM2, and SHM3. In this instance, the water swelling capacity was measured in terms of the increase in thickness as compared to the original thickness of the SA-SHM film. As can be seen from the graph of FIG. 7, SHM1, SHM2, and SHM3 each increased in thickness by more than 100 times their original thicknesses. Further, SHM1 and SHM3 exhibited a faster absorption rate than SHM2. Generally, a faster absorption rate is more advantageous for copper or optical fiber cable applications.

Advantageously, embodiments of the telecommunications enclosures using SAP for sealing enhance effectiveness of telecommunications enclosures used to protect optical fiber splices or copper connections from the environment. Indeed, the SAP can be used as the primary sealing mechanism for the enclosure or as a secondary sealing mechanism to absorb water that leaks past the primary gasket.

Further, while telecommunications enclosures were described herein by way of illustration, in other embodiments, the enclosure can be used to protect optical components, opto-electrical components, electrical components, or wireless components. For example, optical components include the splice region between the optical fibers of two cables that are spliced within the enclosure. Other optical components include connectors, ports, repeaters, switches, and the like. In exemplary embodiments, opto-electrical components also include connectors, ports, repeaters, switches, and the like that utilize both electrical and optical signals or that convert electrical signals to optical signals and vice versa. Further, in exemplary embodiments, wireless components include routers, terminals, receivers, antennas, and the like. The enclosure for each of these applications is sized to accommodate the particular components placed therein, and the combination of SAP tapes, yarns, fabrics, powders, or gaskets described herein is able to prevent the ingress of water into the internal cavities of such enclosures during the operational lifetime of these enclosures.

Also described herein is a method of manufacturing a telecommunications equipment enclosure using SAP. The method includes forming a first portion, such as the lid 14, having a first sealing surface, such as the first peripheral surface 17. The method also includes forming a second portion, such as the bin portion 12, having a second sealing surface, such as the second peripheral surface 18, wherein the first portion and the second portion define an internal cavity 20 when the first sealing surface contacts the second sealing surface and the first portion and the second portion are in a closed configuration. The method also includes placing a first gasket, such as the peripheral gasket 28, on either the first sealing surface or the second sealing surface. The method also includes placing a superabsorbent polymer (SAP) on at least one of the first portion and the second portion for restricting ingress of water into the internal cavity 20 when the first portion and the second portion are in the closed configuration.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be interred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A telecommunications equipment enclosure, comprising:
a first portion having a first sealing surface;
a second portion having a second sealing surface, wherein the first portion and the second portion define an internal cavity when the first sealing surface contacts the second sealing surface and the first portion and the second portion are in a closed configuration;
a first gasket on either the first sealing surface or the second sealing surface; and
superabsorbent polymer (SAP) located on at least one of the first portion and the second portion for restricting ingress of water into the internal cavity when the first portion and the second portion are in the closed configuration;
wherein the SAP is not located between the first sealing surface and the second sealing surface when the first portion and the second portion are in the closed configuration.

2. The telecommunications equipment enclosure of claim 1, wherein the first sealing surface, the second sealing surface, and the SAP circumscribe the internal cavity.

3. The telecommunications equipment enclosure of claim 1, wherein the first sealing surface and the second sealing surface circumscribe the internal cavity, wherein the SAP only partially circumscribes the internal cavity.

4. The telecommunications equipment enclosure of claim 1, wherein the SAP circumscribes the internal cavity and the first gasket circumscribes the SAP.

5. The telecommunications equipment enclosure of the claim 4, wherein the first gasket is located on the first sealing surface and further comprising a second gasket on either the first sealing surface or the second sealing surface, wherein the second gasket circumscribes the internal cavity and wherein the SAP is located between the first gasket and the second gasket when the first portion and the second portion are in the closed configuration.

6. The telecommunications equipment enclosure of claim 5, wherein the first gasket, the second gasket, or both the first and second gaskets have an open cell porosity.

7. The telecommunications equipment enclosure of claim 5, wherein the first gasket, the second gasket, or both the first and second gaskets have a closed cell porosity.

8. The telecommunications equipment enclosure of claim 1, wherein the SAP is located between the first gasket and the first sealing surface or the second sealing surface when the first portion and the second portion are in the closed configuration.

9. The telecommunications equipment enclosure of claim 1, wherein the SAP is located between the first sealing surface and the second sealing surface when the first portion and the second portion are in the closed configuration.

10. (canceled)

11. The telecommunications equipment enclosure of claim 1, wherein the SAP is in the form of a powder, fabric, or tape.

12. The telecommunications equipment enclosure of claim 1, wherein the SAP is in the form of a hot melt.

13. The telecommunications equipment enclosure of claim 12, wherein the hot melt has a thickness of from 0.05 mm to 10 mm.

14. The telecommunications equipment enclosure of claim 1, wherein the SAP is capable of absorbing from 50 grams to 1000 grams of water per gram of SAP.

15. The telecommunications equipment enclosure of claim 14, wherein the SAP is capable of absorbing from 100 grams to 500 grams of water per gram of SAP.

16. The telecommunications equipment enclosure of claim 1, wherein the SAP comprises at least one of sodium or potassium sodium acrylate or acrylamide copolymers, cross-linked carboxymethylcellulose, ethylene maleic anhydride copolymers, cross-linked polyethylene oxide, polyvinyl alcohol copolymers, or starch-grafted copolymers of polyacrylonitrile.

17. The telecommunications equipment enclosure of claim 1, wherein the first gasket and the SAP are configured to prevent the ingress of water into the internal cavity while the telecommunications equipment enclosure is submerged under 15 cm of water for 30 min.

18. An telecommunications equipment enclosure, the system comprising:
a first portion having a first sealing surface;
a second portion having a second sealing surface, wherein the first portion and the second portion define an internal cavity when the first sealing surface contacts the second sealing surface and the first portion and the second portion are in a closed configuration;
a first gasket on either the first sealing surface or the second sealing surface;
a second gasket on either the first portion or the second portion, wherein the second gasket comprises a superabsorbent polymer (SAP) and wherein the second gasket is capable of absorbing from 50 grams to 1000 grams of water per gram of SAP; and
a third gasket on either the first sealing surface or the second sealing surface, wherein the second gasket is positioned between the first gasket and the third gasket when the first portion and the second portion are in a closed configuration.

19. The telecommunications equipment enclosure of claim 18, wherein the SAP comprises at least one of sodium or potassium sodium acrylate or acrylamide copolymers, cross-linked carboxymethyl cellulose, ethylene maleic anhydride copolymers, cross-linked polyethylene oxide, polyvinyl alcohol copolymers, or starch grafted copolymers of polyacrylonitrile.

20. (canceled)

21. The telecommunications equipment enclosure of claim 19, wherein the second gasket, the third gasket, or both the second and third gaskets have an open cell porosity.

22. The telecommunications equipment enclosure of claim 21, wherein the second gasket, the third gasket, or both the second and third gaskets have a closed cell porosity.

23. A method of manufacturing an telecommunications equipment enclosure, comprising:
forming a first portion having a first sealing surface;
forming a second portion having a second sealing surface, wherein the first portion and the second portion define an internal cavity when the first sealing surface contacts the second sealing surface and the first portion and the second portion are in a closed configuration;
placing a first gasket on either the first sealing surface or the second sealing surface; and
placing a superabsorbent polymer (SAP) on at least one of the first portion and the second portion for restricting ingress of water into the internal cavity when the first portion and the second portion are in the closed configuration, wherein the SAP is not located between the first sealing surface and the second sealing surface when the first portion and the second portion are in the closed configuration.

24. (canceled)
